(19) United States
(12) Patent Application Publication
(10) Pub. No.: US 2009/0165272 A1
(43) Pub. Date: Jul. 2, 2009

(54) CLUTCH PACKING TOOL AND SETTING GAUGE

(75) Inventors: Vijay Krishan MEHTA, New Delhi (IN); Sanju PRASAD, Faridabad (IN); Ram Phal Singh DALAL, Faridabad (IN)

Correspondence Address: Workman Nydegger;1000 Eagle Gate Tower, 60 East South Temple, Salt Lake City, UT, 84111, US

(73) Assignee: CLUTCH AUTO LIMITED, New Delhi (IN)

(21) Appl. No.: 12/345,322

(22) Filed: Dec. 29, 2008

(30) Foreign Application Priority Data
Dec. 27, 2007 (IN) 2741/DEL/2007

(51) Int. Cl. B25B 27/00; B23P 19/04

(52) U.S. Cl. 29/274; 7/164; 7/100

(57) ABSTRACT

Present invention provides a tool for packing and setting a clutch assembly. The tool has a pair of arms and a connecting member. The pair of arms has a length, a width and a height and are substantially parallel to each other. The arms are connected at one end to the connecting member. The arms are adaptable to be placed in between a bearing cage and a cover of the clutch assembly wherein the height of the arms is so configured to keep different components of the clutch assembly in position when the clutch assembly is not installed in a vehicle.

### FIELD OF THE INVENTION

The present invention relates to a tool for clutches and more particularly relates to a tool for holding and retaining position of release bearing with respect to clutch cover during assembly, storage, transportation, mounting and removing the clutch from flywheel and that can also act as a gauge at the time of adjustment of the clutch.

### BACKGROUND OF THE INVENTION

Clutches are well known mechanisms used in automobiles, which are devices adapted to typically connect a driven means and a rotational power source. The rotational power source is usually the crankshaft of an automobile engine. A clutch device is having an engaged position and a disengaged position. Typically a plurality of springs is used to provide load on the pressure plate to move the clutch to engaged position. The Clutch system consists of clutch disc, pressure plate assembly and the flywheel. The pressure plate assembly is bolted to the flywheel and clutch disc is sandwiched between pressure plate assembly and the flywheel. When the clutch is engaged, the pressure plate holds the clutch disc tightly against the flywheel allowing engine power to drive the transmission. When the clutch is released, the pressure plate is pulled back away from the flywheel allowing the clutch disc to spin freely.

After manufacturing/assembling when the clutches are not installed on the vehicle a pre-determined gap is required to be maintained between the clutch cover and the bearing cage for keeping the various parts of the clutch in assembled position. The pre-determined gap also helps in easy and correct installation of the clutch. During clutch manufacturing the position of bearing cage is maintained and measured on an assembly fixture and a packing is placed in the gap between the clutch cover and the release bearing while the cover is clamped. The thickness of the packing is less than the gap available. After the clamping is removed the release bearing in a pull type clutch moves towards clutch cover to rest upon the packing. It has been the normal practice to keep a loose wooden piece as packing, between the cover and the bearing that falls itself when the clutch is mounted on the flywheel. Further at the time of service of the clutches the pressure plate assembly needed to be set, for a particular position of bearing, so that the contacting yoke with a definite stroke can be used for disengaging & engaging the clutch optimally. Setting of the clutch is always defined as the position of clutch release bearing with reference to the flywheel clutch mounting face when the clutch is in mounted condition. The gap between release bearing and clutch cover top is used as a reference. During working as the clutch wears, the gap between the clutch cover and the release bearing reduces making it difficult to operate the clutch. Hence it needs to be adjusted. The wooden piece packing is prone to breakage and cannot serve the purpose of a packing as well as setting gauge.

Some of the clutch uses a special clutch brake fitted on transmission input shaft and is placed between clutch release bearing and transmission face. The gap between the clutch brake face and release bearing top face is also used as another reference to define clutch adjustment.

Hence there is a requirement for a stable tool that can be used as a packing for clutches during its assembly, storage, transportation, mounting and removing them from flywheel and can act as a setting gauge during the life of the clutches. The tool of the present disclosure solves one or more of the problems set forth above.

### SUMMARY

The principal object of the present invention is to provide a means/tool to retain release bearing in such a position that it is safe to transport and also easily mountable to the flywheel.

It is yet another object of the present invention to provide a setting gauge, which can be used for settings during the adjustment of the clutch during service.

It is yet another object of the present invention to provide stable packing tool for clutches.

It is yet another object of the present invention to provide a setting gauge cum packing tool made up of a durable material.

It is yet another object of the present invention to provide a cost effective setting gauge/packing tool.

It is yet another object of the present invention to provide a lightweight and stable setting gauge cum packing tool that can be used throughout the life of clutch.

According to one embodiment of the present invention to achieve the above-mentioned objects, a tool is provided for a clutch assembly. The tool has a pair of arms and a connecting member. The pair of arms has a length, a width and a height and are substantially parallel to each other. The arms are connected at one end to the connecting member.

In yet another embodiment the tool may further have a handle. The handle is attached to the connecting member.

In yet another embodiment the clutch assembly may include a bearing cage and a cover and the arms are adaptable to be placed in between the bearing cage and the cover of the clutch assembly wherein the height of the arms is so configured to keep different components of the clutch assembly in position when the clutch assembly is in a disassembled state.

In yet another embodiment the arms, the connecting member and the handle may be so molded to form a single element.

### BRIEF DESCRIPTION OF THE DRAWINGS

A more complete appreciation of the present invention will be understood by reference to the following detailed description when considered in conjunction with the accompanying drawings in which like reference symbols indicate the same or similar components, wherein:

FIG. 1 illustrates clutch assembly mounted on to the flywheel.

FIG. 2 illustrate the cross sectional view of the clutch in shipping position.

FIG. 3 shows the isometric view of a clutch with a tool according to an embodiment of the present invention.

FIG. 4 illustrates a tool according to an embodiment of the present invention.

FIG. 5 illustrates a tool according to another embodiment of the present invention.

FIG. 6 illustrates a tool according to yet another embodiment of the present invention.

FIG. 7 illustrates a tool according to yet another embodiment of the present invention.

FIG. 8 illustrates a tool according to yet another embodiment of the present invention.

FIG. 9a illustrates a cross-section pattern of the arms of a tool according to an embodiment of the present invention.

FIG. 9b illustrates a cross-section pattern of the arms of a tool according to yet another embodiment of the present invention.

FIG. 9c illustrates a cross-section pattern of the arms of a tool according to yet another embodiment of the present invention.

### DETAILED DESCRIPTION OF THE DRAWINGS

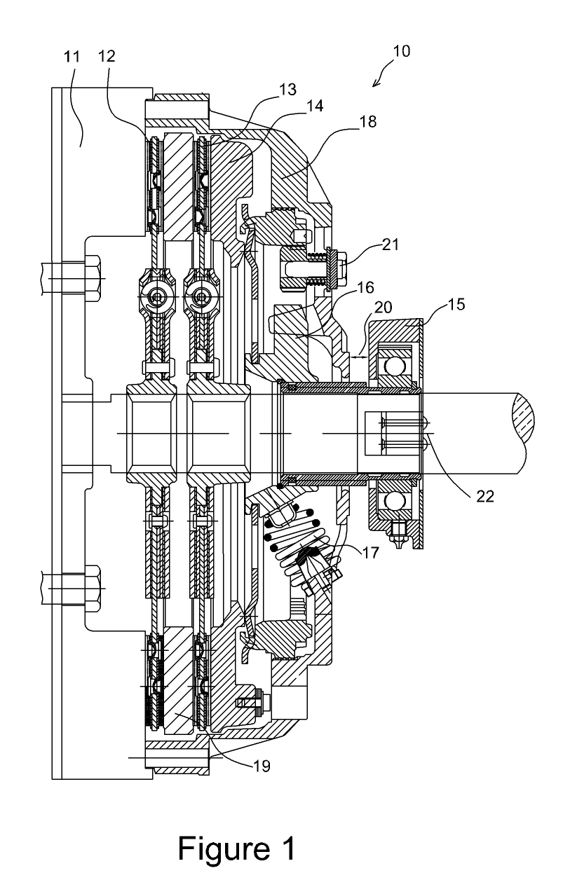

Turning now to the drawings and referring first to FIG. 1, a pull type clutch assembly 10 mounted on to a flywheel 11 is shown. The clutch assembly 10 includes a pressure plate 14, a release bearing 15, a retainer 16, plurality of pressure spring 17 and a cover 18. One or more clutch discs 12 & 13 may be sandwiched between the flywheel 11 and the pressure plate 14. An intermediate plate 19 may be placed between the clutch discs 12 & 13 if the number of clutch disc is more then one.

At the time of manufacturing, the clutch assembly is mounted on a fixture representing the flywheel 11 and a suitable gap 20 between the release bearing 15 and the clutch cover 18 is maintained by rotating an adjuster bolt 21. This causes the retainer 16 and the release bearing 15 to move along a clutch axis 22. During working as the clutch wears the gap 20 between the release bearing 15 and the clutch cover 18 decreases. The change in the gap 20 between the release bearing 15 and the clutch cover 18 affects the operating characteristics of the clutch assembly 10. It is essentially required to maintain appropriate gap 20 between the release bearing 15 and the clutch cover 18 for proper working of the clutch assembly 10. The gap 20 depends on the size of the clutch and type of application.

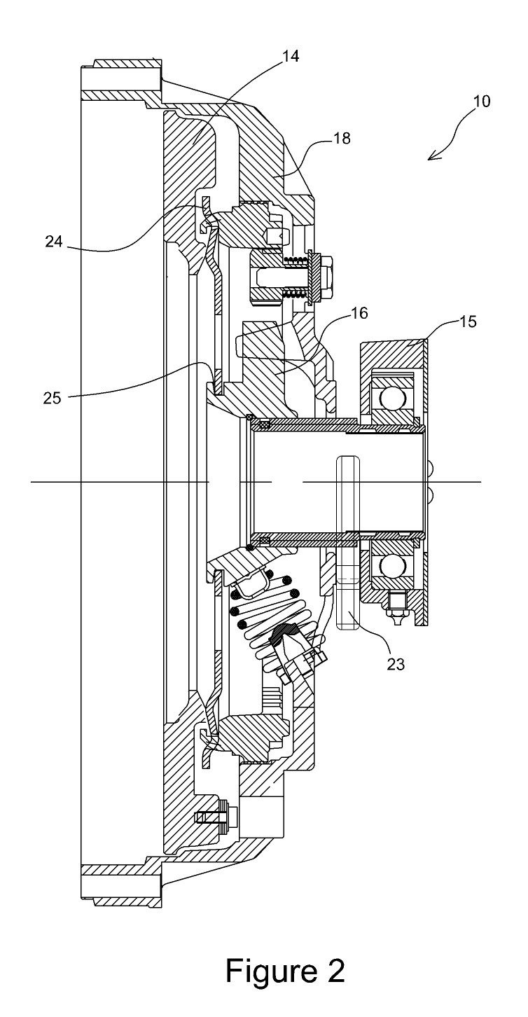

FIG. 2 illustrate the cross sectional view of the clutch assembly 10 during shipping with a tool 23 in position according to an embodiment of the present invention. The tool 23 is placed between the release bearing 15 and the clutch cover 18. In the absence of the tool 23, the release bearing 15 will tend to move towards the clutch cover 18 causing the retainer 16 to move towards the fixture representing flywheel 11 (not shown) triggering clutch levers 24 to come out of groove 25 of the retainer 16. Once the clutch assembly 10 is mounted on the flywheel 11 and the clutch mounting bolts (not shown) are tightened, the pressure plate 14 is pushed away from the flywheel 11 and in turn the retainer 16 along with the release bearing 15 is also pushed. This causes the tool 23 to get loose and can come out easily.

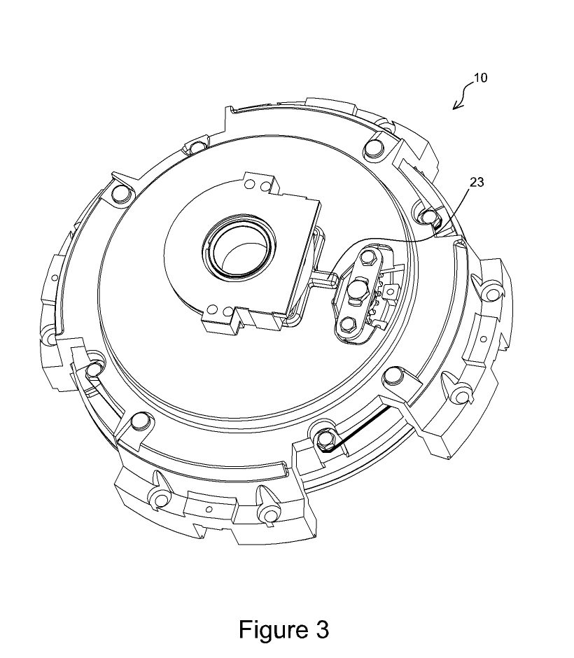

FIG. 3 illustrates an isometric view of the clutch assembly 10 exemplifying the position of tool 23 in the clutch assembly 10 according to an embodiment of the present invention. It is to be appreciated that like numerals are used to identify components depicted in FIG. 1 and FIG. 2 and the associated description provided in the above paragraphs are also applicable to same components appearing in FIG. 3.

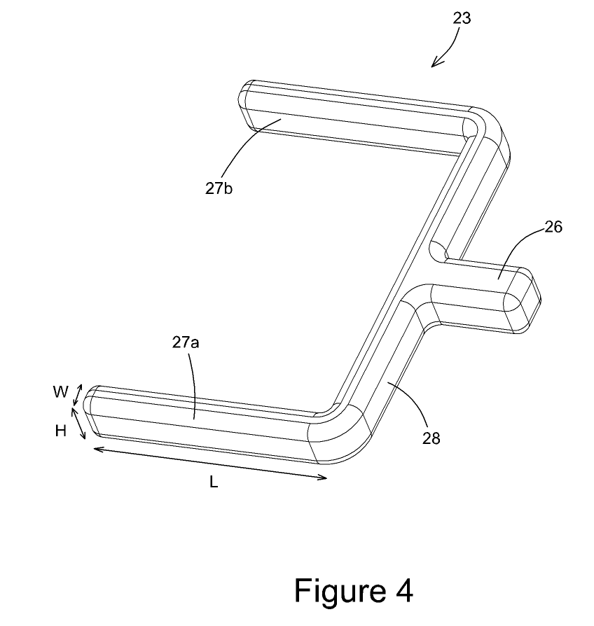

FIG. 4 and FIG. 5 illustrates the tool 23 according to an embodiment of the present invention. It is to be appreciated that like numerals are used to identify components depicted in FIG. 1 to FIG. 3 and the associated description provided in the above paragraphs are also applicable to same components appearing in FIG. 4 and FIG. 5. As illustrated the tool 23 have a pair of substantially straight arms 27a, 27b substantially parallel to each other. The distance between the arms 27a 27b is such that the tool 23 can be easily placed in the clutch under the release bearing 15 and contacts the clutch cover 18. The arms 27a, 27b have a suitable predefined length (L), breadth (W) and height (H). In one embodiment the height (H) of the arms 27a, 27b is less than the gap 20 so that the tool 23 can be easily placed or removed when the clutch is installed. In one embodiment the height (H) of the arms 27a, 27b is so configured that once the clutch assembly 10 is mounted on the flywheel 11 and the release bearing 15 takes its position, the tool 23 is automatically gets loosened and drops off or can be removed manually.

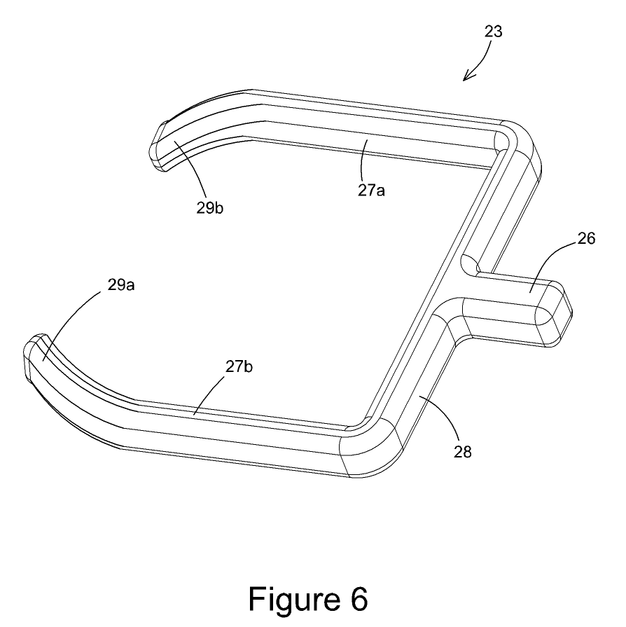

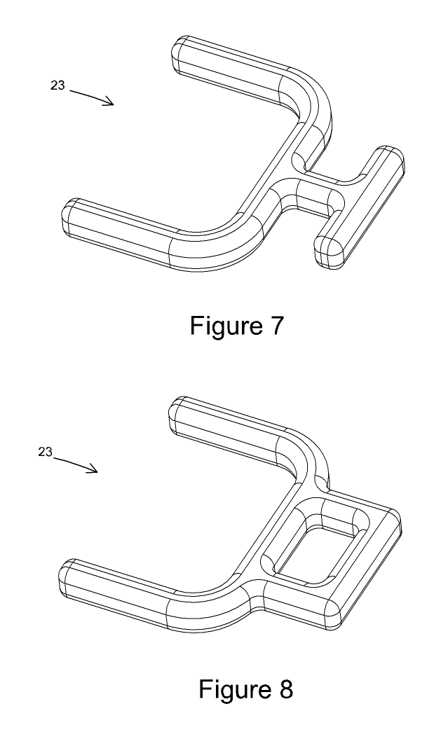

Further the arms 27a, 27b at their one end are connected to a connecting member 28 such that one arm is arranged at each end of the connecting member 28. In one embodiment the connecting member is substantially flat as shown in FIG. 4. In yet another embodiment the connecting member may be curved shaped as shown in FIG. 5. The connecting member 28 may have a handle 26 attached thereto. According to one embodiment of the present invention the handle 26 is configured to have a free end in a direction vertically opposite to the direction of a free end of the arms 27a, 27b. In yet another embodiment the handle 26 may be connected at the center of the connecting member 28. In yet another embodiment the handle 26 is substantially perpendicular to the connecting member 28. The handle 26 assists in placing and removing the tool 23 in place. The handle 26 may further have a suitable shape and grip for handling the tool 23 such as but not limited to as shown in FIG. 7 and FIG. 8. The tool 23 is installed in place at the time of assembly in the manufacturing shop and retained in position during storage, transportation and until the clutch assembly 10 is mounted on the flywheel 11. Such an arrangement ensures that at no point of time, the lever 24 can tend to come out of the groove 25 of the retainer 16.

In yet another embodiment the arms 27a, 27b, the connecting member 28 and the handle 26 are rigidly attached by a bonding agent such as but not limited to adhesive or by suitable fastening means such as but not limited to nut bolts, screws etc. In yet another embodiment the arms 27a, 27b, the connecting member 28 and the handle 26 of the tool 23 may be so molded such as to form a single element.

In one embodiment the tool 23 is made up of a synthetic material such as but not limited to nylon, Polyamide (PA), Polyurethane (PU) Polypropylene (PP), Polystyrene (PS), High impact polystyrene (HIPS), Acrylonitrile butadiene styrene (ABS), Polyethylene terephthalate (PET), Polyester (PES), Poly vinyl chloride (PVC), Polycarbonate (PC), Polyvinylidene chloride (PVDC), Polyethylene (PE), Polycarbonate/Acrylonitrile Butadiene Styrene (PC/ABS), Polymethyl methacrylate (PMMA), Polytetrafluoroethylene (PTFE), Polyetheretherketone (PEEK), Polyetherimide (PEI), Phenolics (PF) or (phenol formaldehydes), Urea-formaldehyde (UF), Melamine formaldehyde (MF), Polylactic acid, Plastarch material or any other suitable synthetic plastic material. In yet another embodiment the tool 23 is made up of a metal such as but not limited to Steel, Aluminum, Brass, Bronze etc. or any sort of composite material. In yet another embodiment the tool 23 may be made up of any other durable material including wood.

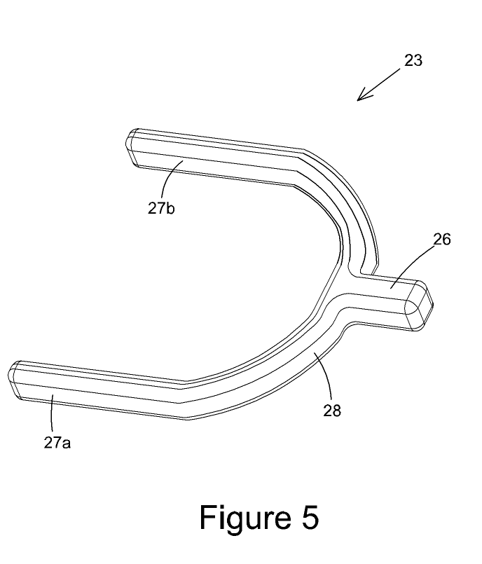

FIG. 6 illustrates the tool 23 according to yet another embodiment of the present invention. It is to be appreciated that like numerals are used to identify components depicted in FIG. 1 to FIG. 5 and the associated description provided in the above paragraphs are also applicable to same components appearing in FIG. 5. As illustrated the tool 23 have a pair of substantially straight arms 27a, 27b substantially parallel to each other. The arms 27a, 27b have a suitable predefined length (L), breadth (W) and height (H). The arms 27a, 27b at their one end are connected to a connecting member 28 such that one arm is arranged at each end of the connecting member 28. The other end of the arms 27a, 27b are so configured to effectively secure the tool 23 in position when the tool 23 is installed on the clutch assembly 10, such that the tool 23 can only be removed manually from its place. In one embodiment the arms 27a, 27b at the other end have an inwardly curved protrusions 29a, 29b for effectively securing the tool 23 after it is being installed as packing for clutches. The connecting member 28 have a handle 26 attached thereto. The handle 26 is so configured to have a free end in a direction vertically opposite to the direction of a free end of the arms 27a, 27b.

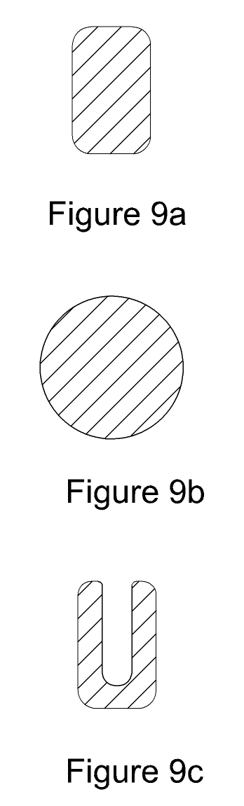

FIG. 9a, FIG. 9b and FIG. 9c illustrates cross-section patterns of the arms 27a, 27b of the tool 23 according to different embodiments of the present invention. The tool 23 may have a rectangular cross section as shown in FIG. 9a, or can have a circular or oval cross section as shown in FIG. 9b or can have a u-shaped cross section as shown in FIG. 9c, it is to be understood that the disclosure is not limited thereto, but may be otherwise variously other suitable cross section patterns may be implemented with in the scope of the invention.

While certain present preferred embodiments of the invention and certain preferred methods of practicing the same have been illustrated and described herein, it is to be understood that the disclosure is not limited thereto, but may be otherwise variously embodied and practiced within the scope of the following claims.

We claim:

1. A tool for packing and setting a clutch assembly comprising:
a pair of arms parallel to each other, maintained at a suitable distance, each arm having a length, a breadth and a height, the arms being connected at one end to a connecting member.

2. The tool for packing and setting a clutch assembly as claimed in claim 1, further comprising a handle attached to said connecting member.

3. The tool for packing and setting a clutch assembly as claimed in claim 1, wherein the clutch assembly includes a bearing cage and a cover;
wherein the arms are adaptable to be placed in between the bearing cage and the cover and the height of the arms is so configured to keep the different components of the clutch assembly in position when the clutch assembly is in a disassembled state

4. The tool for packing and setting a clutch assembly as claimed in claim 1, wherein the connecting member is substantially flat.

5. The tool for packing and setting a clutch assembly as claimed in claim 1, wherein the connecting member is curved shaped.

6. The tool for packing and setting a clutch assembly as claimed in claim 2, wherein the handle is attached at a center position on the connecting member.

7. The tool for packing and setting a clutch assembly as claimed in claim 1, wherein the tool is made up of a synthetic material.

8. The tool for packing and setting a clutch assembly as claimed in claim 7, wherein the synthetic material being selected from nylon, Polyamide (PA), Polyurethane (PU) Polypropylene (PP), Polystyrene (PS), High impact polystyrene (HIPS), Acrylonitrile butadiene styrene (ABS), Polyethylene terephthalate (PET), Polyester (PES), Poly vinyl chloride (PVC), Polycarbonate (PC), Polyvinylidene chloride (PVDC), Polyethylene (PE), Polycarbonate/Acrylonitrile Butadiene Styrene (PC/ABS), Polymethyl methacrylate (PMMA), Polytetrafluoroethylene (PTFE), Polyetheretherketone (PEEK), Polyetherimide (PEI), Phenolics (PF) or (phenol formaldehydes), Urea-formaldehyde (UF), Melamine formaldehyde (MF), Polylactic acid, Plastarch material or any other suitable synthetic plastic material.

9. The tool for packing and setting a clutch assembly as claimed in claim 1, wherein the tool is made up of a metal or a composite material

10. The tool for packing and setting a clutch assembly as claimed in claim 1, wherein the arms, the connecting member and the handle are so molded to form a single element.
